(19) United States
(12) Patent Application Publication
(10) Pub. No.: US 2004/0195029 A1
(43) Pub. Date: Oct. 7, 2004

(54) Vehicle occupant gas-contact restraining system

(76) Inventor: Yakov Feldman, West Hollywood, CA (US)

Correspondence Address: YAKOV FELDMAN, APT. 215, 7705 HAMPTON AVE., WEST HOLLYWOOD, CA, 90046, US

(21) Appl. No.: 10/405,179

(22) Filed: Apr. 2, 2003

(51) Int. Cl. B60N 2/42

(52) U.S. Cl. 180/271; 297/216.1

(57) ABSTRACT

A vehicle occupant gas-contact restraining system including at least one gas generator or gas source located within a vehicle and adapted to discharge a gas flow which flows between a seat back of a vehicle seat and a vehicle occupant seated on the vehicle seat when the gas generator or gas source is activated or actuated during a vehicle collision. The gas flow is adapted to come into contact with the occupant's body to form an enlarged occupant-contact area, and to generate a force which pushes or attracts the vehicle occupant toward the seat back of the vehicle seat, thereby reducing an inertial force of the occupant's body and restraining the vehicle occupant from forward inertial movement during the vehicle collision. The entire process of restraining the vehicle occupant takes place in a fraction of a second, and it will not interfere with the driver's visibility or the ability to steer or operate other controls.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a vehicle occupant restraining system, in particular to a gas-contact restraining system which discharges a flow of gas into a space between a seat back of a vehicle seat and a vehicle occupant seated on the vehicle seat within a vehicle and which restrains the vehicle occupant from forward inertial movement during a vehicle collision.

Starting in model year 1999, the federal government required automakers to install driver and passenger air bags for frontal protection in all cars, light trucks, and vans. Still, about 30,000 occupants die in crashes on U.S. roads each year. Most of these people die in frontal crashes.

For reducing a chance of injury in a crash, all occupants, sitting in vehicles having air bags, should be properly restrained, regardless of size. All front seat passengers (adults and children) should move the seat as far rearward as possible, and may tilt the seat back slightly to help maximize the distance between the passenger's chest and the instrument panel. In order to allow the air bag to deploy safely, front seat passengers should avoid leaning or reaching forward, keeping the arms away from the area in which the air bag will deploy, and should remain seated against the vehicle seat back, with as little slack in the belt as possible to minimize forward movement in a crash.

Air bags inflate with great force. If occupants unrestrained, leaning forward, sitting side ways or out of position in any way, they are at greater risk of injury or death in a crash and may also receive serious or fatal injuries from the air bag if driver or passenger is up against it when it inflates.

A big risk of serious or fatal injury offer current air bags to identifiable groups of people, for example, people who cannot avoid sitting extremely close to air bags, people with certain medical conditions, elderly people, and young children.

Some number of people may still be at risk because they will be more likely than the general population to be too close to their air bags.

When the steering wheel and the dashboard air bags inflate, a fairly loud noise may be heard, followed by release of smoke. This smoke is actually powder from the airbag's surface. The smoke may cause irritation and choking. Those with a history of breathing trouble should get fresh air promptly.

The energy required to inflate air bags can injure occupants on top of, or very close to, air bags as they begin to inflate. In the first few milliseconds of inflation, the forces can seriously injure anyone struck by and inflating air bag. Serious inflation injuries occur because of occupants' positions when the air bags begin inflating. Anyone on top of, or very close to, an air bag as it begins to inflate is at risk. This is why most air bag deaths involve occupants who were positioned improperly. Other occupants at risk include drivers who sit or who lean forward in their seats, so they are very close to the steering wheel, infants in rear-facing restrains, and small children, positioned in front of passenger air bags. The more serious injuries range from broken arms and ribs to torn heart valves and bruised lungs. Air bags had caused the death of many occupants in low speed crashes.

Research indicates that air bags mainly kill infants, children, short women, and the elderly. Most deaths are the result of severe injuries to the brain, spinal or heart.

### BRIEF SUMMARY OF THE INVENTION

This invention is directed to a vehicle occupant gas-contact restraining system for restraining and protecting a vehicle occupant during a vehicle collision.

The object of the present invention is to provide a restraining system which restrains a vehicle occupant from forward inertial movement during a vehicle collision.

The vehicle occupant gas-contact restraining system comprises: means for sensing a crash of a vehicle and at least one gas generator or gas source assembly including a gas generator or gas source, a guide device or nozzle, and mounting studs extending from the gas generator or gas source for mounting the entire gas generator or gas source assembly to any suitable vehicle structure.

The gas generator or gas source assembly can also includes an expander for increasing an active or a gas-discharge area of the gas generator or gas source.

The gas generator or gas source assembly is adapted to discharge a gas flow which flows between or along a seat back of a vehicle seat and a vehicle occupant seated on the vehicle seat within a vehicle when the gas generator or source of gas is activated or actuated during a vehicle collision.

The gas flow can be directed upward along the seat back of the vehicle seat and the vehicle occupant's body.

The gas flow is adapted to come into contact with the vehicle occupant's body to form an enlarged occupant-contact area, and to generate a force (according to Bernoulli's equation, Newton's first and third laws, and the Coanda effect) which pushes or attracts the vehicle occupant toward the seat back of the vehicle seat, thereby reducing an inertial force of the vehicle occupant's body and restraining the vehicle occupant from forward inertial movement or from movement to a side where the vehicle is impacted during the vehicle collision.

The gas flow can have a predetermined, or an adjustable, or a modulative force or power based on crash severity, on position of the vehicle occupant relative to the seat back of the vehicle seat, and on weight of a vehicle occupant.

The gas generator or source of gas can have an elongated shape or other shapes.

The gas flow is directed or guided into a space between the seat back of the vehicle seat and the vehicle occupant through a guide device or nozzle. At least a portion of the guide device or nozzle is made of a flexible material.

The guide device or nozzle has wall portions surrounding the gas generator or gas source, or surrounding the gas generator or gas source and the expander. The wall portions define a guide device or a nozzle interior containing the gas generator or gas source with or without the expander substantially therein such that the gas generator or gas source with or without the expander are or is enclosed within the guide device or nozzle. At least a portion of the guide device or nozzle is deployable upon generation of the gas flow by the gas generator or gas source.

In the first embodiment, the guide device or nozzle includes a frangible seam being breakable to define a guide device or a nozzle deployment opening which is adapted to permit discharging of the gas flow out. The frangible seam of the guide device or nozzle closes the deployment opening and can be independent, or can be joined to a frangible seam of the vehicle seat outer trim cover.

In the second embodiment, the wall portions of the guide device or nozzle define an unsealed seam being openable to define a guide device or a nozzle deployment opening which is adapted to permit discharging of the gas flow out.

In all of the embodiments, the guide device or nozzle deployment opening can have an elongated shape or other shapes during deployment.

The gas generator or gas source assemblies may be located in a vehicle seat of a vehicle or at any other suitable locations within the vehicle.

When the gas generator or gas source assembly is located or disposed in a vehicle seat of a vehicle, the vehicle seat has an outer trim cover defining a frangible seam therein for deployment of the discharging gas flow. The outer trim cover encloses a foam cushion defining a recess for receiving the gas generator or gas source assembly, and the foam cushion has a deployment line from proximate the recess to proximate the frangible seam in the outer trim cover. The deployment line is a narrow slit in the foam cushion.

The gas generator or gas source is designed to generate a gas flow in a moderate to severe frontal collision.

The entire process of a gas generation, a discharging of a gas flow, and a stop of the gas generation takes place in a fraction of a second, and it will not interfere with the driver's visibility, or the ability to steer or operate other controls.

In comparison with current air bags in existing and new vehicles which may cause serious or fatal injuries during a vehicle collision described in the “Background of the invention,” the objects and advantages of the vehicle occupant gas-contact restraining system of the present invention, during a vehicle collision, are:

(a) to provide a gas-contact restraining system which restrains and protects an occupant, sitting in vehicle seat, from moving to a side where the vehicle is impacted and from receiving serious or fatal injuries;

(b) to provide a gas-contact restraining system which reliably stops the occupant's body independently of the occupant's height and age;

(c) to provide a gas-contact restraining system which secures an occupant independently from a distance to the dashboard or steering wheel for the front seat occupant, and from a distance to the seat back of the front seats for the rear seat occupant; and

(d) to provide a gas-contact restraining system which secures an occupant independently of the occupant's position in the seat.

Additional objects, advantages, and features of the present invention will become apparent from the following detailed description, taken together with the accompanying drawings.

### BRIEF DESCRIPTION OF THE SEVERAL VIEWS OF THE DRAWING

The present invention, both as to its structure and manner of operation, may best be understood by referring to the following detailed description, taken in accordance with the accompanying drawings in which:

FIG. 1 is a perspective view of a vehicle seat with a vehicle occupant seated on that seat within a vehicle and including a gas-contact restraining system in accordance with an embodiment of the present invention, shown in a condition prior to actuation;

FIG. 2 is a side view of the vehicle seat including a gas-contact restraining system, shown in a condition prior to actuation;

FIG. 3 is a view similar to FIG. 2, but showing the gas-contact restraining system in an actuated condition during a vehicle collision;

FIG. 4 is a front view of FIG. 3;

FIG. 5 is an enlarged side view of the gas-contact restraining system of FIG. 2, showing an embodiment including a gas generator and a guide device with a frangible seam;

FIG. 6 is an enlarged side view of the gas-contact restraining system of FIG. 2, but showing another embodiment including a gas generator, an expander, and a guide device with a frangible seam;

FIG. 7 is an enlarged side view of the gas-contact restraining system of FIG. 2, but showing another embodiment including a gas generator, an expander, and a guide device with an unsealed seam; and

FIG. 8 is an enlarged side view of the gas-contact restraining system of FIG. 3.

### DETAILED DESCRIPTION OF THE INVENTION

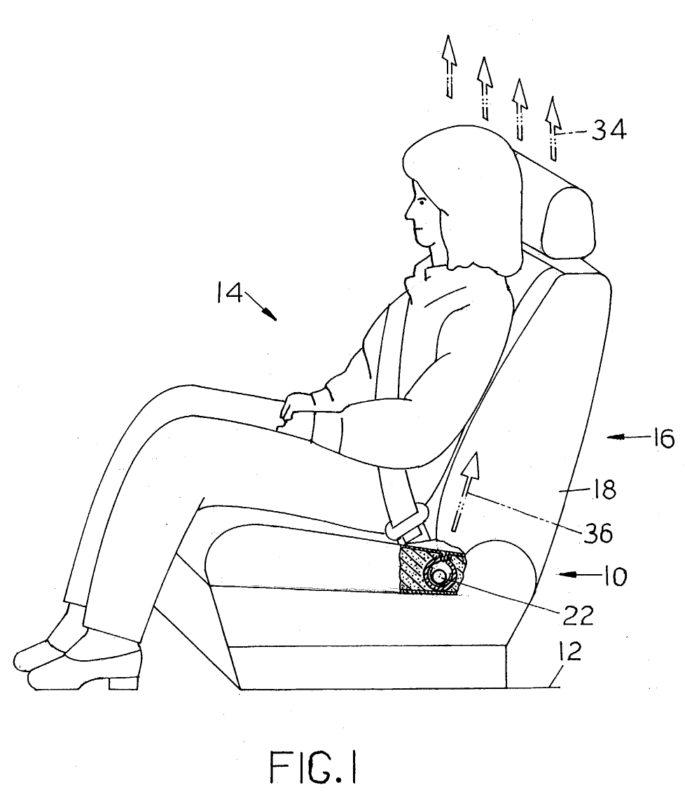

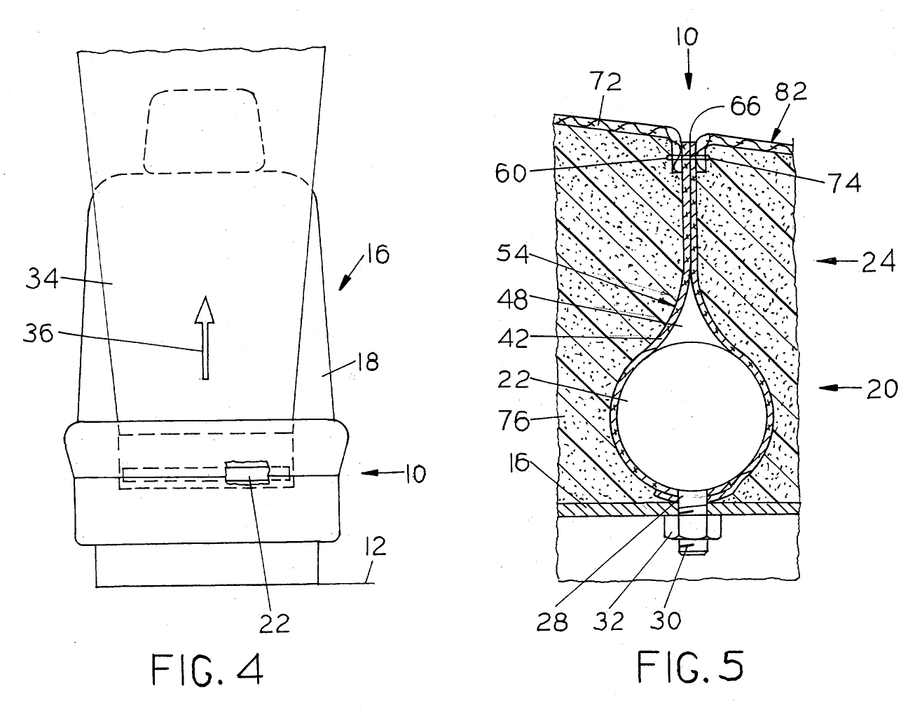

A vehicle occupant gas-contact restraining system of the present invention is shown in FIGS. 1-8. The vehicle occupant gas-contact restraining system 10 comprises: means for sensing a crash of a vehicle (not shown) and at least one gas generator or gas source assembly 20 (FIGS. 5-8) including a gas generator or gas source 22 (FIGS. 1-8), a guide device or nozzle 24 (FIGS. 5-8), and mounting studs 28 (FIGS. 5-8) extending from the gas generator or gas source 22 for mounting the entire gas generator or gas source assembly 20 to any suitable vehicle structure.

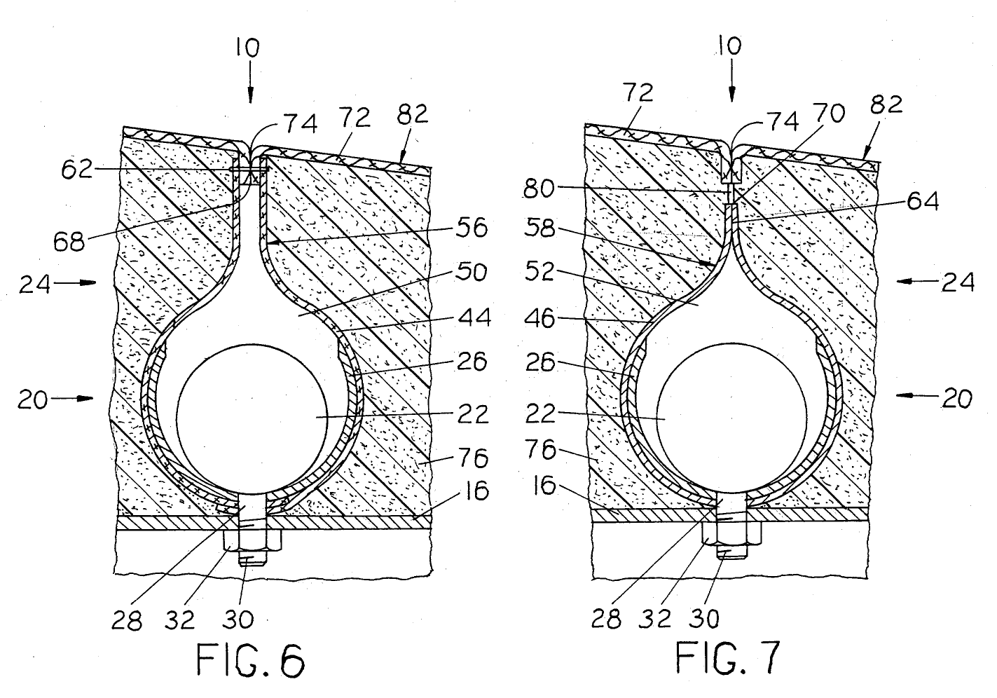

The gas generator or gas source assembly 20 can also includes an expander 26 (FIGS. 6-8) for increasing an active or a gas-discharge area of the gas generator or gas source 22.

The gas generator or gas source assembly 20 is adapted to discharge a gas flow 34 (FIGS. 1,3,4, and 8) which flows between or along a seat back 18 of a vehicle seat 16 and a vehicle occupant 14 (FIG. 1) seated on the vehicle seat 16 within a vehicle 12, as shown by an arrow 36, when the gas generator or source of gas 22 is activated or actuated during a vehicle collision.

The gas flow 34 can be directed upward along the seat back 18 of the vehicle seat 16 and the vehicle occupant's body 14, as shown by an arrow 36.

The gas flow 34 is adapted to come into contact with the vehicle occupant's body 14 to form an enlarged occupant-contact area, and to generate a force (according to Bernoulli's equation, Newton's first and third laws, and the Coanda effect) which pushes or attracts the vehicle occupant 14 toward the seat back 18 of the vehicle seat 16, thereby reducing an inertial force of the vehicle occupant's body and restraining the vehicle occupant from forward inertial movement or from movement to a side where the vehicle is impacted during the vehicle collision.

The gas flow 34 can have a predetermined, or an adjustable, or a modulative force or power based on crash severity, on position of the vehicle occupant 14 relative to the seat back 18 of the vehicle seat 16, and on weight of a vehicle occupant.

The gas generator or gas source 22 contains chemicals for igniting to generate gas for discharge upon the existence of vehicle conditions. The gas generator or gas source 22 is rigid and preferably has an axially elongated cylindrical body including ports (not shown) through which the generator gas discharges.

The elongated mounting studs 28 (FIGS. 5-8) are secured to the body of the gas generator 22 and extend radially outwardly therefrom for attachment to any suitable vehicle 12 structure. The mounting studs 28 preferably each have a threaded end 30 for receiving a nut 32 thereon.

The gas flow 34 is directed or guided into a space between the seat back 18 of the vehicle seat 16 and the vehicle occupant 14 through a guide device or nozzle 24 (FIGS. 5-8). At least a portion of the guide device or nozzle 24 is made of a flexible material which is suitable for guide device or nozzle construction.

Referring to FIG. 5, the guide device or nozzle 24 is coupled to the gas generator or gas source 22 or the wall portions 42 of the guide device or nozzle 24 surround the gas generator or gas source 22 and define a guide device or a nozzle interior 48 containing the gas generator or gas source 22 substantially therein such that the gas generator or gas source 22 is enclosed within the guide device or nozzle 24. At least a portion of the guide device or nozzle 24 is deployable upon generation of the gas flow by the gas generator or gas source 22.

Referring to FIGS. 6 and 7, the guide device or nozzle 24 has wall portions 44 or 46 surrounding the gas generator or gas source 22 and the expander 26 and defining a guide device or a nozzle interior 50 or 52 containing the gas generator or gas source 22 and the expander 26 substantially therein such that the gas generator or gas source 22 are enclosed within the guide device or nozzle 24.

The guide device or nozzle 24 includes a deployment portion 54 (FIG. 5), or 56(FIG. 6), or 58 (FIG. 7) which is deployable upon the discharge of the generator gas. The deployment portion 54, 56, and 58 may be made of a single piece of a flexible material or of several flexible panels joined together.

The wall portions 42, 44, and 46 of the guide device or nozzle 24 and the expander 26 each include stud apertures through which the mounting studs 28 outwardly protrude for attachment to the vehicle 12 structure.

In the first embodiment, the guide device or nozzle 24 includes a frangible seam 60 (FIG. 5) or 62 (FIG. 6) being breakable to define a guide device or a nozzle deployment opening 66 or 68 which is adapted to permit discharging of the gas flow out. The frangible seam 60 or 62 of the guide device or nozzle 24 closes the deployment opening 66 or 68 and can be independent (not shown), or can be joined to a frangible seam 74 (FIGS. 5 and 6) of the vehicle seat outer trim cover 72.

In the second embodiment, the wall portions 46 (FIG. 7) of the guide device or nozzle 24 define an unsealed seam 64 being openable to define a guide device or a nozzle deployment opening 70 which is adapted to permit discharging of the gas flow out.

In all of the embodiments, the guide device or nozzle deployment opening 66, or 68, or 70 can have an elongated shape or other shapes during deployment.

The gas generator or gas source assemblies 20 may be located in a vehicle seat 16 of a vehicle 12 or at any other suitable locations within the vehicle.

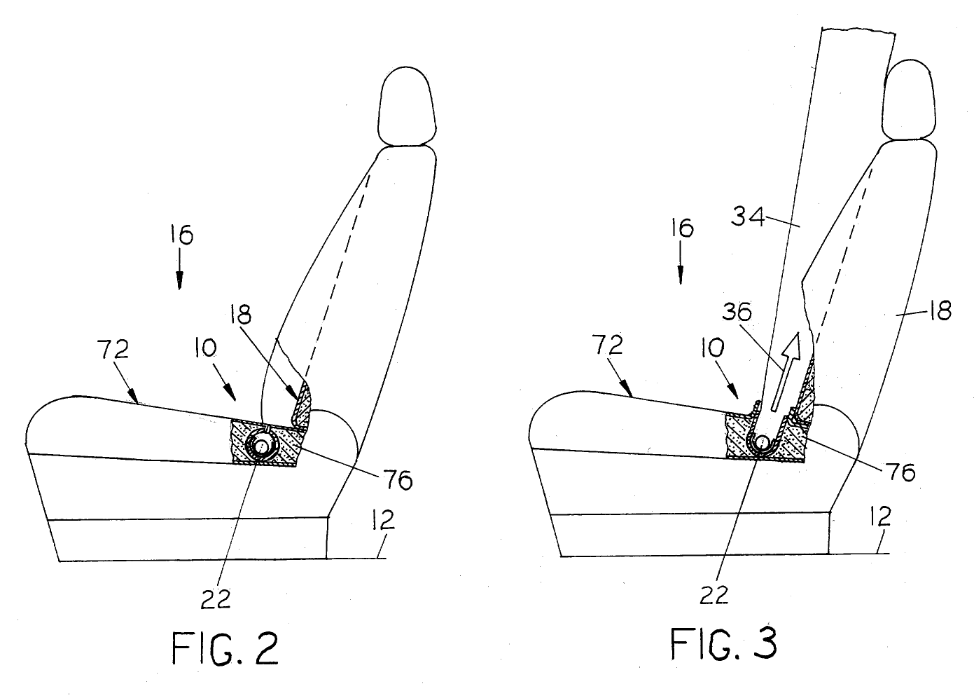

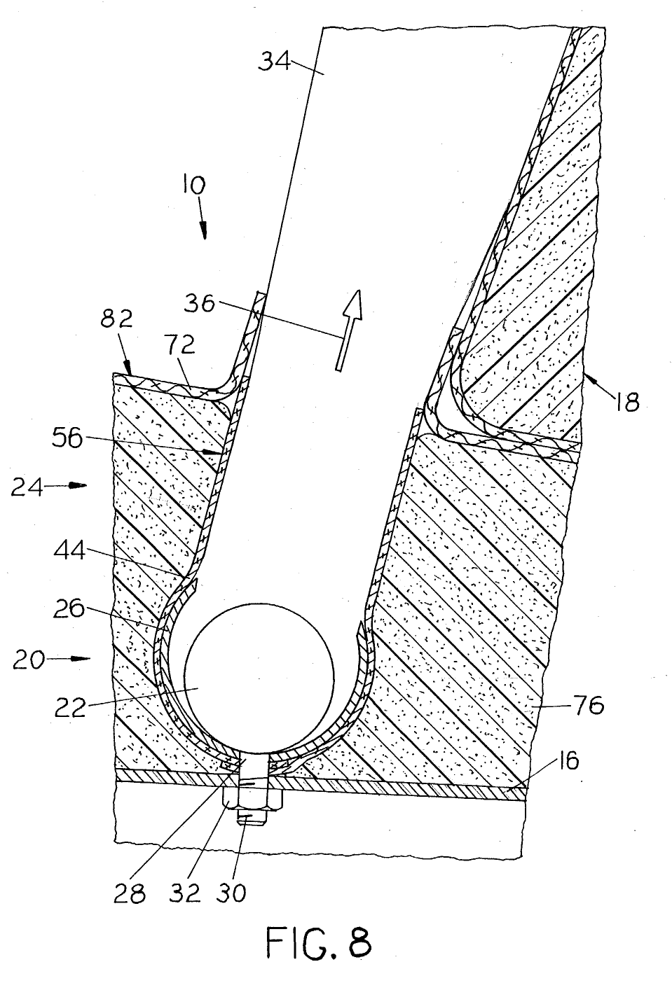

When the gas generator or gas source assembly 20 is located or disposed in a vehicle seat 16 of a vehicle 12, the vehicle seat 16 has an outer trim cover 72 defining a frangible seam 74 therein for deployment of the discharging gas flow 34 (FIGS. 3 and 8). The outer trim cover 72 encloses a foam cushion 76 (FIGS. 2, 3, and 5-8) defining a recess for receiving the gas generator or gas source assembly 20 (FIGS. 5-8), and the foam cushion 76 has a deployment line 80 (FIG. 7) from proximate the recess to proximate the frangible seam 74 in the outer trim cover 72. The deployment line 80 is a narrow slit in the foam cushion 76.

Prior to deployment, the frangible seam 60 (FIG. 5) or 62(FIG. 6) or the unsealed seam 64 (FIG. 7) of the guide device or nozzle 24 is preferably aligned with the frangible seat seam 74 of the vehicle seat 16. The frangible seam 60 or 62 or the unsealed seam 64 of the guide device or nozzle 24 is located proximate the outer surface of the seat 16 by being placed proximate or in the deployment line 80 in foam cushion 76, while the rigid gas generator 22 is oriented away from the outer surface of the seat 16. Thus, the gas generator or gas source assembly 20 only has soft components facing the outer surface of the seat 16. Advantageously, this enables the gas generator or gas source assembly 20 to be located closely beneath the outer surface of the seat 16 while maintaining the comfort of the seat 16 for the vehicle occupant 14 seated on the seat.

Referring to FIGS. 3, 4, and 8, when the gas generator or gas source 22 is activated or actuated upon a signal from a sensor (not shown), the gas generator or gas source 22 discharges the gas flow 34 in a direction toward the frangible seam 60 (FIG. 5) or 62 (FIG. 6) or the unsealed seam 64 (FIG. 7) of the guide device or nozzle 24. The deployment portion 54 (FIG. 5), or 56 (FIG. 6), or 58 (FIG. 7) of the guide device or nozzle 24 expands and breaks open the frangible seam 60 (FIG. 5) or 62 (FIG. 6), or opens the unsealed seam 64 (FIG. 7) of the guide device or nozzle 24 such that the gas flow 34 may flow out through the deployment opening 66 (FIG. 5), or 68 (FIG. 6), or 70 (FIG. 7) of the guide device or nozzle 24. The gas flow 34 also deforms the foam material 76 of the cushion portion 82 and breaks open the frangible seat seam 74 such that the gas flow 34 flows out through the deployment opening 66, or 68, or 70 and along the outer surface of the seat back 18 adjacent to the vehicle occupant 14 seated on the vehicle seat 16 (FIG. 1).

The gas generator or gas source 22 is designed to generate a gas flow 34 in a moderate to severe frontal collision.

The entire process of a gas generation, a discharging of a gas flow, and a stop of the gas generation takes place in a fraction of a second, and it will not interfere with the driver's visibility, or the ability to steer or operate other controls.

In comparison with current air bags in existing and new vehicles which may cause serious or fatal injuries during a vehicle collision, the present invention of the vehicle occupant gas-contact restraining system will allow to protect a great number of occupants from receiving serious or fatal injuries.

While there has been shown and described preferred embodiments of the vehicle occupant gas-contact restraining system of this invention, it is understood that various changes and modifications may be made by those skilled in the art without departing from the invention. The invention is defined in the following claims.

I claim:

1. A vehicle occupant gas-contact restraining system comprising:
at least one gas generator located in a vehicle seat of a vehicle and adapted to discharge a gas flow which flows between a seat back of said vehicle seat and a vehicle occupant seated on said vehicle seat when said at least one gas generator is activated during a vehicle collision;
said gas flow being adapted to come into contact with the body of said vehicle occupant to form an occupant-contact area, and to generate a force which pushes said vehicle occupant toward said seat back of said vehicle seat, so as to reduce an inertial force of said body of said vehicle occupant and to restrain said vehicle occupant from forward inertial movement during said vehicle collision.

2. The vehicle occupant gas-contact restraining system of claim 1 wherein: said gas generator includes a nozzle for directing said gas flow into a space between said seat back and said vehicle occupant when said gas generator discharges said gas flow.

3. The vehicle occupant gas-contact restraining system of claim 2 wherein: at least a portion of said nozzle is made of a flexible material.

4. The vehicle occupant gas-contact restraining system of claim 2 wherein: said nozzle has wall portions surrounding said gas generator, said wall portions define a nozzle interior containing said gas generator substantially therein such that said gas generator is enclosed within said nozzle.

5. The vehicle occupant gas-contact restraining system of claim 2 wherein: said nozzle includes a frangible seam being breakable to define a nozzle deployment opening.

6. The vehicle occupant gas-contact restraining system of claim 5 wherein: said nozzle deployment opening has an elongated shape during deployment.

7. The vehicle occupant gas-contact restraining system of claim 1 wherein: said gas generator includes an expander for increasing a gas-discharge area of said gas generator.

8. A vehicle occupant gas-contact restraining system comprising:
at least one gas generator adapted to discharge a gas flow which flows between at least a portion of a seat back of a vehicle seat and a vehicle occupant seated on said vehicle seat within a vehicle when said at least one gas generator is actuated during a vehicle crash of a selected severity;
said gas flow being adapted to come into contact with said vehicle occupant's body to form an enlarged contact surface with said vehicle occupant's body, and to generate a force to push said vehicle occupant toward said seat back of said vehicle seat, thereby reducing an inertial force of said vehicle occupant's body and restraining said vehicle occupant from movement to a side where the vehicle is impacted during said vehicle crash of a selected severity.

9. The vehicle occupant gas-contact restraining system of claim 8 further comprising: at least one guide device for directing said gas flow between said at least a portion of a seat back and said vehicle occupant when said gas generator discharges said gas flow.

10. The vehicle occupant gas-contact restraining system of claim 9 wherein: at least a portion of said guide device is made of a flexible material.

11. The vehicle occupant gas-contact restraining system of claim 9 wherein: said guide device has wall portions surrounding said gas generator, said wall portions define a guide device interior containing said gas generator substantially therein such that said gas generator is housed within said guide device.

12. The vehicle occupant gas-contact restraining system of claim 11 wherein: said wall portions of said guide device define an unsealed seam being openable to define a guide device deployment opening.

13. The vehicle occupant gas-contact restraining system of claim 12 wherein:
said guide device deployment opening has an elongated shape during deployment.

14. The vehicle occupant gas-contact restraining system of claim 8 further comprising: at least one expander for increasing a gas-discharge surface of said gas generator.

15. A vehicle occupant gas-contact restraining system comprising:
at least one gas source disposed within a vehicle and adapted to discharge a gas flow which flows along a seat back of a vehicle seat and a vehicle occupant seated on said vehicle seat within said vehicle when said at least one gas source is actuated during a vehicle collision;
said gas flow being adapted to come into contact with said vehicle occupant's body and to generate a force which attracts said vehicle occupant toward said seat back of said vehicle seat, thereby reducing an inertial force of said vehicle occupant's body and restraining said vehicle occupant from forward inertial movement during said vehicle collision.

16. The vehicle occupant gas-contact restraining system of claim 15 further comprising: at least one nozzle for guiding said gas flow between said seat back and said vehicle occupant when said source of gas discharges said gas flow.

17. The vehicle occupant gas-contact restraining system of claim 16 wherein: said nozzle is adapted to direct said gas flow upward along said vehicle occupant's body adjacent to said seat back of said vehicle seat.

18. The vehicle occupant gas-contact restraining system of claim 16 wherein: at least a portion of said nozzle is made of a flexible material.

19. The vehicle occupant gas-contact restraining system of claim 16 wherein: said nozzle is coupled to said source of gas.

20. The vehicle occupant gas-contact restraining system of claim 16 wherein: at least a portion of said nozzle is deployable upon generation of said gas flow by said source of gas.
